(19) United States
(12) Patent Application Publication
(10) Pub. No.: US 2011/0000084 A1
(43) Pub. Date: Jan. 6, 2011

(54) Method for repairing a sealing segment of a gas turbine

(75) Inventor: Anja Lange, Langenhagen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/315,233

(22) Filed: Dec. 1, 2008

(30) Foreign Application Priority Data
Dec. 1, 2007 (DE) DE 102007057930.8

(51) Int. Cl. B23P 6/00

(52) U.S. Cl. 29/888.021

(57) ABSTRACT

A method for repairing a sealing segment of a gas turbine is provided. The sealing segment includes a radially outer holding portion for a radially inner abradable portion. The method includes the steps of providing a sealing segment to be repaired; removing a damaged, radially inner abradable portion of the sealing segment along a circumferentially extending parting plane, such that the abradable portion is completely removed from the holding portion; making a replacement part for the separated abradable portion of the sealing segment; and joining the replacement part to the holding portion of the sealing segment.

This application claims priority to German Patent Application DE 10 2007 057 930.8, filed Dec. 1, 2007, which is incorporated by reference herein.

The present invention relates to a method for repairing a sealing segment of a gas turbine.

### BACKGROUND

Present-day gas turbines, in particular aircraft engines, must meet exceedingly stringent requirements in terms of reliability, weight, performance, economy and service life. The selection of material, the search for new types of suitable material, as well as the quest for novel manufacturing and repair techniques play a decisive role in gas turbine development.

To boost performance, it is vitally important that all components and subsystems be optimized. These also include the sealing systems concerned here. Maintaining a minimal gap between the rotating rotor blades and the fixed casing of a high-pressure turbine is especially problematic in the context of aircraft engines. In high-pressure turbines, the task of maintaining the gap is complicated by the extremely high temperatures and temperature gradients occurring therein.

The ends or tips of the rotating rotor blades are subjected to direct frictional contact with the sealing segments of the fixed casing during what is known as rubbing contact. Such rubbing contact of the blade tips is due to manufacturing tolerances and occurs when setting a minimal radial gap. Since the frictional contact of the blade tips causes material to be ablated from said tips and from the sealing segments, the gap can become undesirably enlarged over the entire periphery of the casing and rotor.

Consequently, the sealing segments are subject to wear. Other types of damage mechanisms that may occur include thermomechanical fatigue and local overheating, resulting in cracks and burned areas. Therefore, such sealing segments must either be replaced or repaired during maintenance.

The repair techniques known in the field allow only repair of certain types of localized damage on sealing segments or shrouds. When larger or more dramatic damage has occurred to a sealing segment or shroud, such sealing segment or shroud cannot be repaired, bust must be completely replaced. Therefore, there exists a need for a method for repairing sealing segments that allows a sealing segment to be repaired even when major damage has occurred thereto.

### SUMMARY OF THE INVENTION

In view of the above, it is an object of the present invention to provide a novel method for repairing a sealing segment of a gas turbine. The method according to one embodiment of the present invention includes at least the following steps:

a) providing a sealing segment to be repaired;

b) removing the damaged, radially inner abradable portion of the sealing segment along a circumferentially extending parting plane, such that the abradable portion is completely removed from the holding portion;

c) making a replacement part for the separated abradable portion of the sealing segment;

d) joining the replacement part to the holding portion of the sealing segment.

The repair method of one embodiment of the present invention proposes that an inner abradable portion of a sealing segment to be repaired be completely removed from the holding portion of the sealing segment, and that a replacement part for the separated abradable portion be joined to the remaining holding portion. The repair method allows sealing segments to be repaired even if severely damaged.

### BRIEF SUMMARY OF THE DRAWING

Preferred embodiments of the present invention will become apparent from the dependent clams and from the following description. Non-limiting exemplary embodiments of the present invention will be described in more detail with reference to the drawing, in which:

FIG. 1 is a schematic perspective view of a sealing segment.

### DETAILED DESCRIPTION

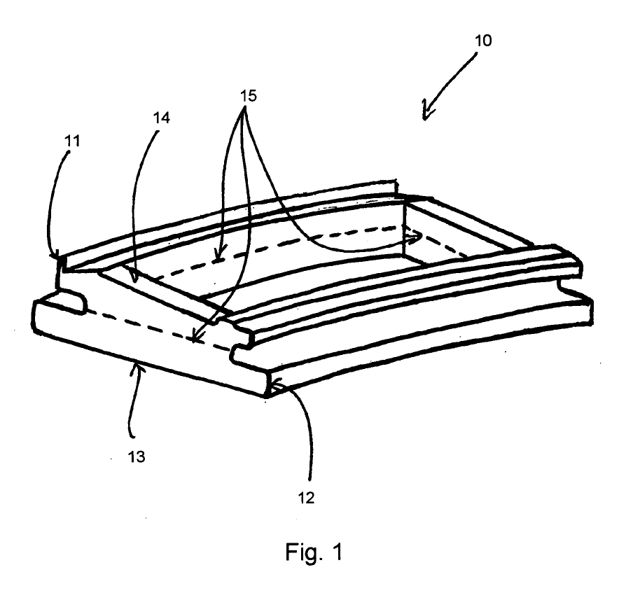

One embodiment of the present invention will now described in more detail with reference to FIG. 1.

This embodiment of the present invention is directed to a method for repairing or reconditioning sealing segments secured to the casing of a gas turbine.

FIG. 1 shows a sealing segment 10 of a gas turbine in a schematic perspective view. Sealing segment 10 includes a radially outer, frame-like holding portion 11 for a radially inner abradable portion 12. Via holding portion 11, a sealing segment 10 can be secured to a stator casing of the gas turbine.

Radially inner abradable portion 12 provides an abradable coating for contact with the tips of rotating rotor blades. Sealing segment 10 typically has a continuous closed surface 13 in the region of radially inner abradable portion 12, whereas in the region of radially outer frame-like holding portion 11, sealing segment 10 has a surface 14 which is not closed.

When such a sealing segment 10 is damaged and is to be repaired, the sealing segment 10 to be repaired is made ready for repair and, subsequently, radially inner abradable portion 12 of sealing segment 10 is separated from radially outer holding portion along a circumferentially extending parting plane 15 (illustrated by dashed lines in FIG. 1), and, more specifically, such that abradable portion 12 is completely removed from holding portion 11.

After that, a replacement part for the separated abradable portion of the sealing segment is provided, preferably in the form of a casting.

Then, the replacement part is joined to the holding portion of the sealing segment, in particular by brazing or welding.

If a sealing segment 10 to be repaired is coated with, for example, an antiwear coating, the removal of abradable portion 12 from holding portion 11 is followed by stripping of the remaining holding portion 11. The stripping method is suitably selected according to the type of coating to be removed.

During the repair process, cooling air holes, or slots for receiving sealing plates, can be formed in the replacement part, for example by laser cutting or electric discharge machining. In some instances, the joining of the replacement part to the holding portion may be followed by mechanical machining, in particular of the joint region, and/or by coating of the repaired sealing segment.

What is claimed is:

1. A method for repairing a sealing segment of a gas turbine, the sealing segment including a radially outer holding portion for a radially inner abradable portion, the method comprising:
a) providing a sealing segment to be repaired;
b) removing a damaged, radially inner abradable portion of the sealing segment along a circumferentially extending parting plane, such that the abradable portion is completely removed from the holding portion;
c) making a replacement part for the separated abradable portion of the sealing segment; and
d) joining the replacement part to the holding portion of the sealing segment.

2. The method as recited in claim 1 wherein the step of removing the damaged, radially inner abradable portion is followed by stripping of the radially outer holding portion.

3. The method as recited in claim 1 wherein the replacement part is joined to the holding portion of the sealing segment by welding or brazing.

4. The method as recited in claim 1 wherein the joining step is followed by coating of the repaired sealing segment.

5. The method as recited in claim 1 wherein the joining step is followed by mechanical machining.

6. The method as recited in claim 1 wherein the sealing segment is a sealing segment of an aircraft engine.
